(19) United States
(12) Patent Application Publication
(10) Pub. No.: US 2026/0280708 A1
(43) Pub. Date: Sep. 17, 2026

(54) RECEIVING DEVICE AND OPTICAL WIRELESS COMMUNICATION SYSTEM

(71) Applicant: TOYOTA JIDOSHA KABUSHIKI KAISHA, Aichi-ken (JP)

(72) Inventors: Shintaro SHIBA, Tokyo-to (JP); Norimasa KOBORI, Tokyo-to (JP)

(21) Appl. No.: 19/555,893

(22) Filed: Mar. 4, 2026

(30) Foreign Application Priority Data
Mar. 11, 2025 (JP) 2025-037967

(51) Int. Cl. H04B 10/116; H04B 10/60

(52) U.S. Cl. CPC H04B 10/116; H04B 10/60

(57) ABSTRACT

A receiving device includes: an event camera configured to detect a rising edge and a falling edge of luminance as events; and a controller configured to receive, through the event camera, an optical wireless communication signal transmitted from a transmitting device. A protocol defines how data is represented in the optical wireless communication signal. hen start of reception of the optical wireless communication signal is detected, the controller executes a protocol identification process that identifies an applied protocol applied to the received optical wireless communication signal. After the protocol identification process, the controller recognizes data represented by the optical wireless communication signal based on the applied protocol.

### CROSS-REFERENCES TO RELATED APPLICATION

The present disclosure claims priority to Japanese Patent Application No. 2025-037967, filed on Mar. 11, 2025, the contents of which application are incorporated herein by reference in their entirety.

### TECHNICAL FIELD

The present disclosure relates to an optical wireless communication technique utilizing an event camera.

### BACKGROUND ART

Patent Literature 1 discloses a mobile system. The mobile system has a camera and a processor. The processor uses the camera to captures an image of an optical beacon. The processor determines whether or not a specific object is recognized within the captured image by querying a database. When a specific object is recognized, the processor initiates detection and decoding of data being communicated via visible light communication.

### LIST OF RELATED ART

Patent Literature 1: Japanese Patent Application Publication No. 2020-504490

### SUMMARY

Regarding an optical wireless communication, let us consider a case where a receiving-side receives an optical wireless communication signal through an event camera. Various protocols are conceivable for the optical wireless communication assuming the signal reception by the event camera. If a protocol applied to the received optical wireless communication signal is not identified, it is not possible to accurately recognize data represented by the received optical wireless communication signal.

A first aspect relates to a receiving device.

The receiving device includes:
an event camera configured to detect a rising edge and a falling edge of luminance as events; and
a controller configured to receive, through the event camera, an optical wireless communication signal transmitted from a transmitting device.

A protocol defines how data is represented in the optical wireless communication signal.

When start of reception of the optical wireless communication signal is detected, the controller executes a protocol identification process that identifies an applied protocol applied to the received optical wireless communication signal.

After the protocol identification process, the controller recognizes data represented by the optical wireless communication signal based on the applied protocol.

A second aspect relates to an optical wireless communication system.

The optical wireless communication system includes:
a transmitting device configured to transmit an optical wireless communication signal; and
a receiving device configured to receive the optical wireless communication signal transmitted from the transmitting device.

The receiving device is provided with an event camera that detects a rising edge and a falling edge of luminance as events, and is configured to receive the optical wireless communication signal through the event camera.

A protocol defines how data is represented in the optical wireless communication signal.

The transmitting device encodes transmission data in accordance with a certain applied protocol to generate the optical wireless communication signal.

When start of reception of the optical wireless communication signal is detected, the receiving device executes a protocol identification process that identifies the applied protocol applied to the received optical wireless communication signal.

After the protocol identification process, the receiving device recognizes the transmission data represented by the optical wireless communication signal based on the applied protocol.

According to the present disclosure, the applied protocol applied to the received optical wireless communication signal is identified in response to the start of reception of the optical wireless communication signal. Then, after the protocol identification process, the data represented by the optical wireless communication signal is recognized based on the applied protocol. It is thus possible to accurately recognize the data represented by the optical wireless communication signal, even in a case where there are various protocols for the optical wireless communication utilizing the event camera.

### BRIEF DESCRIPTION OF DRAWINGS

FIG. 1 is a block diagram for explaining an overview of an optical wireless communication system;

FIG. 2 is a conceptual diagram for explaining an event camera;

FIG. 3 is a conceptual diagram for explaining event data;

FIG. 4 is a conceptual diagram showing a comparison between an optical wireless communication signal and noise;

FIG. 5 is a conceptual diagram for explaining an example of a protocol applied to an optical wireless communication utilizing an event camera;

FIG. 6 is a block diagram for explaining processing performed by a controller of a receiving device;

FIG. 7 is a conceptual diagram for explaining a first example of a protocol identification process;

FIG. 8 is a conceptual diagram for explaining a second example of a protocol identification process;

FIG. 9 is a conceptual diagram for explaining a second example of a protocol identification process;

FIG. 10 is a conceptual diagram for explaining a third example of a protocol identification process;

FIG. 11 is a conceptual diagram for explaining examples of setting of sensitivity of an event camera;

FIG. 12 is a block diagram for explaining an example of a sensitivity setting process; and

FIG. 13 is a block diagram for explaining a sensitivity setting process considering an applied protocol.

### DETAILED DESCRIPTION

Embodiments of the present disclosure will be described with reference to the accompanying drawings.

### 1. Optical Wireless Communication Utilizing Event Camera

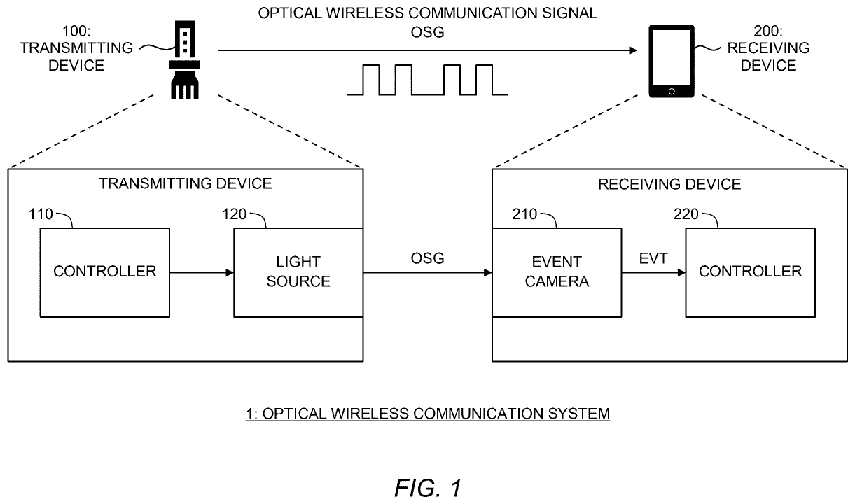

FIG. 1 is a block diagram for explaining an overview of an optical wireless communication system 1 according to the present embodiment. The optical wireless communication system 1 performs an optical wireless communication using light. Here, the term light includes visible light and infrared light. That is to say, the optical wireless communication encompasses both a visible light communication and an infrared light communication. The optical wireless communication system 1 includes a transmitting device 100 and a receiving device 200. The transmitting device 100 transmits (outputs) an optical wireless communication signal OSG composed of blinking of the light. The receiving device 200 receives the optical wireless communication signal OSG transmitted from the transmitting device 100.

The transmitting device 100 includes a controller 110 and a light source 120. The controller 110 includes one or more processors that execute a variety of processing, and one or more storage devices that store a variety of information. Examples of the processor include a central processing unit (CPU), an application specific integrated circuit (ASIC), a field-programmable gate array (FPGA), an integrated circuit, and the like. The processor may also be referred to as processing circuitry. Examples of the storage device include a volatile memory, a non-volatile memory, a hard disk drives (HDD), a solid state drives (SSD), and the like. An example of the light source 120 is a light emitting diode (LED).

The controller 110 encodes transmission data to generate a blinking pattern of the light source 120 that represents the transmission data. That is, the controller 110 converts the transmission data into a blinking pattern of the light source 120. Then, the controller 110 generates (outputs) an optical wireless communication signal OSG representing the transmission data, by causing the light source 120 to blink rapidly according to the blinking pattern.

The receiving device 200 includes an event camera 210 and a controller 220. The controller 220 includes one or more processors that execute a variety of processing, and one or more storage devices that store a variety of information. Examples of the processor include a CPU, an ASIC, an FPGA, an integrated circuit, and the like. The processor may also be referred to as processing circuitry. Examples of the storage device include a volatile memory, a non-volatile memory, an HDD, an SSD, and the like.

The event camera 210 is a camera configured to be capable of detecting a change in luminance as an event for each pixel. More specifically, the event camera 210 is equipped with an event-based vision sensor (EVS). The event-based vision sensor detects a change in luminance exceeding a threshold as an event. An increase in luminance is detected as a positive event, while a decrease in luminance is detected as a negative event. The event is detected for each pixel.

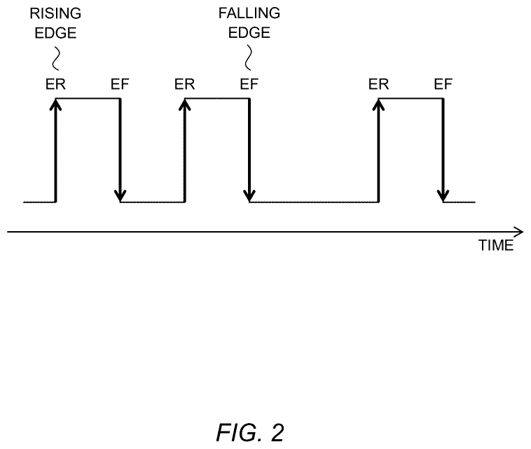

The event camera 210 is also capable of detecting a change in luminance caused by the optical wireless communication signal OSG. As shown in FIG. 2, the optical wireless communication signal OSG includes a rising edge (leading edge) ER which is an increase in luminance, and a falling edge (trailing edge) EF which is a decrease in luminance. The event camera 210 detects the rising edge ER and the falling edge EF as a positive event and a negative event, respectively.

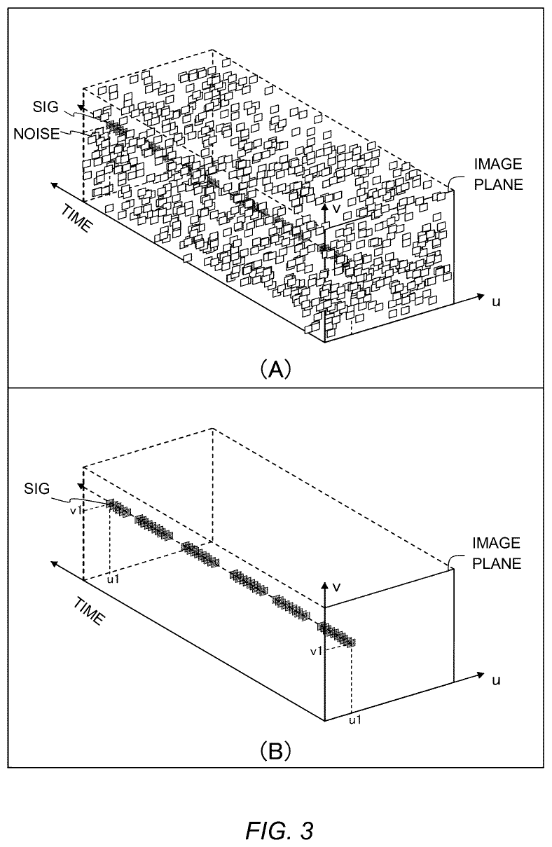

Event data EVT indicate a result of the event detection by the event camera 210. More specifically, the event data EVT represent a temporal and spatial distribution of the events detected by the event camera 210. A part (A) in FIG. 3 is a conceptual diagram illustrating an example of the event data EVT. The event data EVT include not only a signal component SIG corresponding to the optical wireless communication signal OSG caused by the blinking of the light source 120, but also a noise component. For example, the noise component is caused by a change in a position or an orientation of the receiving device 200 (the event camera 210). As another example, the noise component may be caused by a change in a position or an orientation of the transmitting device 100 (the light source 120).

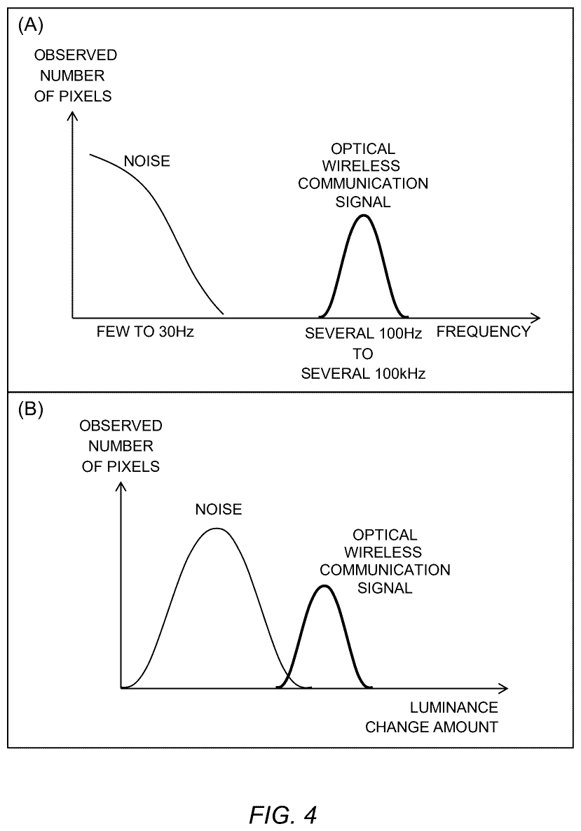

FIG. 4 is a conceptual diagram showing a comparison between the optical wireless communication signal OSG (i.e., the signal component SIG) and the noise.

In a part (A) in FIG. 4, a vertical axis represents the number of pixels at which events are observed, and a horizontal axis represents a frequency. The frequency of the optical wireless communication signal OSG (i.e., the signal component SIG) corresponds to a frequency of the blinking of the light source 120 and ranges from several hundred Hz to several hundred kHz. In contrast, a frequency of the noise is at most several Hz to 30 Hz. That is, there is a remarkable difference in the frequency band between the optical wireless communication signal OSG and the noise. Therefore, it is possible to easily separate the optical wireless communication signal OSG from the noise. For example, using a high-pass filter makes it possible to easily extract the signal component SIG from the event data EVT. A part (B) in FIG. 3 illustrates the signal component SIG extracted from the event data EVT. Coordinates [u1, v1] on an image plane indicate a position of a pixel at which the signal component SIG is obtained, that is, a position of a pixel that has received the optical wireless communication signal OSG. In other words, the coordinates [u1, v1] on the image plane can also be regarded as a position of a pixel at which the light source 120 is shown.

In a part (B) in FIG. 4, a vertical axis represents the number of pixels at which events are observed, and a horizontal axis represents the amount of change in luminance. The amount of change in luminance of the optical wireless communication signal OSG (i.e., the signal component SIG) is greater than that of the noise.

As described above, the event camera 210 is configured to detect a change in luminance as an event for each pixel. Regarding a pixel at which no change in luminance occurs, no event data EVT is generated in particular. On the other hand, a conventional camera needs to generate data for all pixels in every frame. Therefore, as compared with the conventional camera, the event camera 210 has advantages in less data, high-speed processing, and thus high temporal resolution. It can be said that such the high-speed and high temporal resolution event camera 210 has a high degree of affinity for high-speed blinking of the light source 120 such as an LED.

The controller 220 of the receiving device 200 receives the event data EVT indicating the result of the event detection by the event camera 210. Then, the controller 220 extracts the signal component SIG corresponding to the optical wireless communication signal OSG from the event data EVT. For example, the controller 220 extracts the signal component SIG from the event data EVT by utilizing a high-pass filter. Then, the controller 220 decodes the signal component SIG to recognize the data represented by the optical wireless communication signal OSG (i.e., the transmission data transmitted from the transmitting device 100).

As described above, the controller 220 of the receiving device 200 is capable of receiving the high-frequency optical wireless communication signal OSG by utilizing the event camera 210. In other words, the controller 220 is capable of receiving the high-frequency optical wireless communication signal OSG through the event camera 210. Then, the controller 220 decodes the received optical wireless communication signal OSG to recognize the data represented by the optical wireless communication signal OSG (i.e., the transmission data transmitted from the transmitting device 100).

The transmitting device 100 is, for example, installed on a stationary object in a city. Examples of the stationary object in the city include a street lamp, a traffic signal, an electronic display board, and the like. The receiving device 200 is, for example, mounted on a mobile terminal. Examples of the mobile terminal include a smartphone, a tablet, an augmented reality terminal, and the like. As another example, the receiving device 200 may be mounted on a mobility such as a vehicle, a robot, and the like.

One example of applications of the optical wireless communication described above is localization (self-position estimation) by the receiving device 200 (controller 220). More specifically, the transmission data included in the optical wireless communication signal OSG transmitted from the transmitting device 100 indicates a position (an absolute position) of the light source 120 of the transmitting device 100 in an absolute coordinate system. Such the optical wireless communication signal OSG is repeatedly transmitted from the transmitting device 100. The receiving device 200 receives a plurality of optical wireless communication signals OSG from a plurality of transmitting devices 100, respectively. The receiving device 200 decodes the plurality of optical wireless communication signals OSG to recognize the respective absolute positions of the plurality of light sources 120. Meanwhile, the receiving device 200 can also acquire respective image coordinates of the plurality of light sources 120 in the image plane. The receiving device 200 is capable of estimating the position (absolute position) of the receiving device 200 in the absolute coordinate system by combining the respective absolute positions of the plurality of light sources 120 and the respective image coordinates of the plurality of light sources 120.

### 2. Protocol

As described above, according to the present embodiment, the optical wireless communication is performed using the event camera 210. The event camera 210 detects the rising edge ER and the falling edge EF of the optical wireless communication signal OSG as events. Therefore, it is necessary to represent each of data “0” and data “1” based on events.

A protocol defines how data “0” and data “1” are represented in the optical wireless communication signal OSG. In other words, the protocol defines a representation rule for data “0” and “1” in the optical wireless communication signal OSG. In still other words, the protocol defines a conversion rule between data “0” and “1” and the blinking pattern of the light source 120. Various examples are conceivable as the protocol applied to the optical wireless communication utilizing the event camera 210.

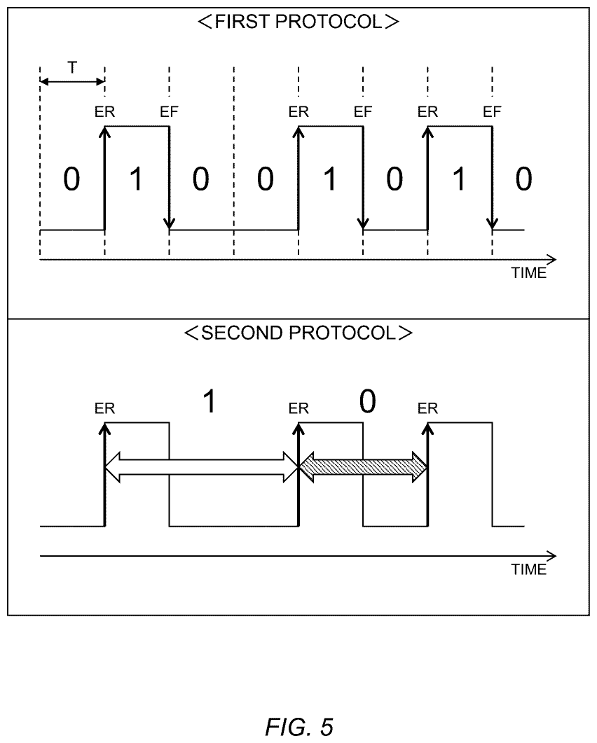

FIG. 5 is a conceptual diagram for explaining examples of the protocol applied to the optical wireless communication utilizing the event camera 210. Herein, two types of protocols, namely a first protocol and a second protocol, are introduced. It should be noted that a reference cycle (period) T is a predetermined cycle that serves as a basis for the data communications. A “rising edge ER”, a “falling edge EF”, or “no luminance change” occurs every reference cycle T.

A first protocol represents data “0” and “1” by using both the rising edge ER and the falling edge EF. More specifically, the first protocol represents data “0” and “1” based on whether or not there is a predetermined pattern of a combination of the rising edge ER and falling edge EF for each reference cycle T. For example, in the example illustrated in FIG. 5, a pair of a rising edge ER and a subsequent falling edge EF is associated with the data “1.” The rising edge ER and the falling edge EF are separated from each other by the reference cycle T. Patterns other than the above-mentioned pattern associated with the data “1” are associated with the data “0.” For example, a pair of a falling edge EF and no luminance change is associated with the data “0.” In addition, a pair of no luminance change and a rising edge ER is associated with the data “0.” Moreover, a pair of a falling edge EF and a subsequent rising edge ER is also associated with the data “0.” A pair of no luminance change and no luminance change is also associated with the data “0.” In the example shown in FIG. 5, it can also be said that the first protocol represents data “0” and “1” based on whether or not a rising edge ER and a falling edge EF occur consecutively in a predetermined order.

On the other hand, a second protocol represents data “0” and “1” by using only one of the rising edge ER and the falling edge EF. More specifically, the second protocol uses only one of the rising edge ER and the falling edge EF as an onset, and represents data “0” and “1” based on an interval (period of time) between consecutive onsets. For example, in the example illustrated in FIG. 5, only the rising edge ER is used as the onset, whereas the falling edge EF is not used. A case where the interval between the consecutive rising edges ER is a first interval being relatively long is associated with the data “1.” On the other hand, another case where the interval between the consecutive rising edges ER is a second interval being relatively short is associated with the data “0.” The first interval is longer than the second interval. For example, the first interval is N times the reference cycle T, and the second interval is M times the reference cycle T. N and M both are integers, and N is greater than M.

The transmitting device 100 generates and transmits the optical wireless communication signal OSG using a certain protocol. Typically, a predetermined protocol is assigned to the transmitting device 100 in advance. Alternatively, the transmitting device 100 may switch between protocols for use as appropriate. In either case, the controller 110 of the transmitting device 100 encodes transmission data in accordance with the certain protocol to generate a blinking pattern of the light source 120 that represents the transmission data. That is to say, the controller 110 converts the transmission data into a blinking pattern of the light source 120 in accordance with the certain protocol. Then, the controller 110 generates (outputs) the optical wireless communication signal OSG representing the transmission data, by causing the light source 120 to blink rapidly according to the blinking pattern.

The controller 220 of the receiving device 200 receives, through the event camera 210, the optical wireless communication signal OSG transmitted from the transmitting device 100. Here, if the protocol applied to the received optical wireless communication signal OSG is not identified, the controller 220 is not able to accurately recognize the data represented by the received optical wireless communication signal OSG. Hereinafter, processing in the receiving device 200 according to the present embodiment will be described.

### 3. Processing in Receiving Device

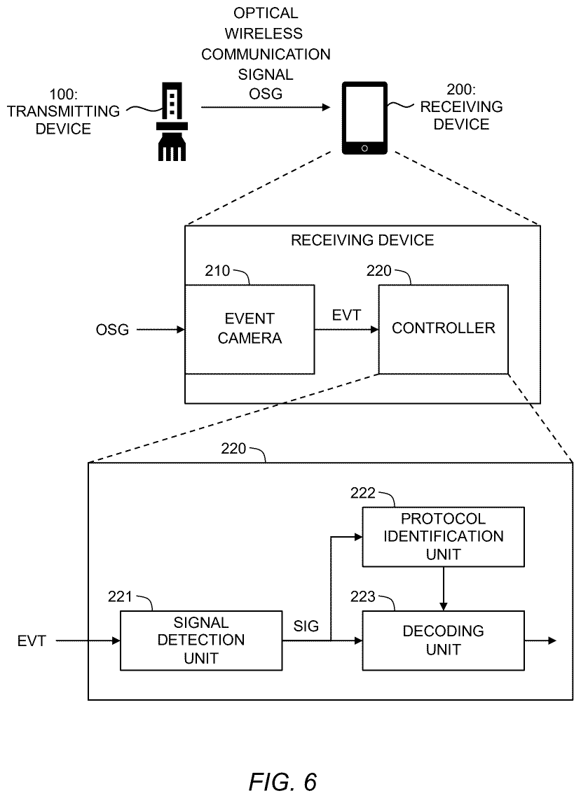

FIG. 6 is a block diagram for explaining the processing performed by the controller 220 of the receiving device 200 according to the present embodiment. The controller 220 includes a signal detection unit 221, a protocol identification unit 222, and a decoding unit 223 as functional blocks.

The signal detection unit 221 receives the event data EVT indicating the result of the event detection from the event camera 210. The signal detection unit 221 detects start (commencement) of reception of the optical wireless communication signal OSG based on the event data EVT.

For example, the signal detection unit 221 detects the start of the reception of the optical wireless communication signal OSG based on the event occurrence frequency at each pixel of the event camera 210. As shown in the part (A) of FIG. 4, there is a remarkable difference in the frequency band between the optical wireless communication signal OSG (i.e., the signal component SIG) and the noise. The frequency band of the optical wireless communication signal OSG is a specific high-frequency band (i.e., several hundred Hz to several hundred kHz). Accordingly, monitoring presence or absence of events of the specific high-frequency band makes it possible to determine whether the reception of the optical wireless communication signal OSG is started or not. More specifically, the signal detection unit 221 calculates the event occurrence frequency for each pixel based on the event data EVT. When the event occurrence frequency falling within the specific high-frequency band is detected, the signal detection unit 221 determines that the reception of the optical wireless communication signal OSG is started, that is, detects the start of the reception of the optical wireless communication signal OSG.

As another example, the signal detection unit 221 may detect the start of the reception of the optical wireless communication signal OSG based on a change in the total amount of the event data EVT observed across all pixels of the event camera 210. As shown in FIG. 3 and FIG. 4, when the reception of the optical wireless communication signal OSG is started, the total amount of the event data EVT increases significantly accordingly. Therefore, monitoring the total amount of the event data EVT makes it possible to detect the start of the reception of the optical wireless communication signal OSG without the need to calculate the event occurrence frequency. For example, when the amount of increase in the event data EVT per unit time exceeds a threshold value, the signal detection unit 221 determines that the reception of the optical wireless communication signal OSG is started, that is, detects the start of the reception of the optical wireless communication signal OSG.

Upon detecting the start of the reception of the optical wireless communication signal OSG, the signal detection unit 221 separates the received optical wireless communication signal OSG from the noise. That is, the signal detection unit 221 extracts the signal component SIG corresponding to the received optical wireless communication signal OSG from the event data EVT. For example, the signal detection unit 221 uses a high-pass filter to extract the signal component SIG of the high-frequency band from the event data EVT.

In response to detecting the start of the reception of the optical wireless communication signal OSG, the protocol identification unit 222 identifies the protocol applied to the received optical wireless communication signal OSG. Hereinafter, the protocol applied to the optical wireless communication signal OSG is referred to as an “applied protocol.” The process of identifying the applied protocol applied to the received optical wireless communication signal OSG is hereinafter referred to as a “protocol identification process.” Various examples can be considered as the protocol identification process. Various examples of the protocol identification process will be described in detail later. The protocol identification unit 222 notifies the decoding unit 223 of information regarding the applied protocol identified.

The decoding unit 223 receives the signal component SIG corresponding to the received optical wireless communication signal OSG from the signal detection unit 221. In addition, the decoding unit 223 receives the information regarding the applied protocol applied to the received optical wireless communication signal OSG from the protocol identification unit 222. After the protocol identification process, the decoding unit 223 decodes the signal component SIG in accordance with the applied protocol to recognize the original data (the transmission data) represented by the optical wireless communication signal OSG. That is, the decoding unit 223 converts the signal component SIG into the original data (the transmission data) in accordance with the applied protocol.

The obtained original data is used in subsequent processes. For example, the obtained original data is used for localization (self-position estimation) of the receiving device 200.

It should be noted that, once the applied protocol is identified by the protocol identification process, the same applied protocol may continue to be used for a predetermined period of time thereafter. After a predetermined period of time has elapsed, the protocol identification process may be performed again.

As described above, according to the present embodiment, the applied protocol applied to the received optical wireless communication signal OSG is identified in response to the start of the reception of the optical wireless communication signal OSG. Then, after the protocol identification process, the data represented by the optical wireless communication signal OSG is recognized based on the applied protocol. It is thus possible to accurately recognize the data represented by the optical wireless communication signal OSG, even in a case where there are various protocols for the optical wireless communication utilizing the event camera 210.

### 4. Examples of Protocol Identification Process

Hereinafter, various examples of the protocol identification process will be described.

### 4-1. First Example

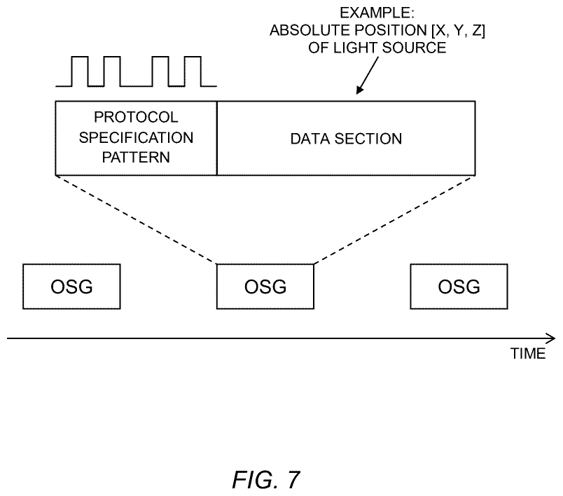

FIG. 7 is a conceptual diagram for explaining a first example of the protocol identification process. In the first example, the optical wireless communication signal OSG having the same content is repeatedly transmitted from the same transmitting device 100.

According to the first example, each optical wireless communication signal OSG includes a “protocol specification pattern” in addition to a data section. The data section is a section that represents the transmission data. On the other hand, the protocol specification pattern indicates the applied protocol that is applied to this optical wireless communication signal OSG. For example, the protocol specification pattern is embedded in a preamble of the optical wireless communication signal OSG.

More specifically, the protocol specification pattern is a pattern of a combination of the rising edge ER and the falling edge EF. When the applied protocol is the first protocol, the protocol specification pattern is a first protocol specification pattern. On the other hand, when the applied protocol is the second protocol, the protocol specification pattern is a second protocol specification pattern. The first protocol specification pattern and the second protocol specification pattern are set to be different from each other, and are given as known patterns.

The controller 110 of the transmitting device 100 retains in advance information regarding the first protocol specification pattern and the second protocol specification pattern. More specifically, the information regarding the first protocol specification pattern and the second protocol specification pattern is stored in the storage device of the controller 110. The controller 110 generates the optical wireless communication signal OSG so as to include the protocol specification pattern indicating the applied protocol.

The controller 220 of the receiving device 200 also retains in advance the information regarding the first protocol specification pattern and the second protocol specification pattern. More specifically, the information regarding the first protocol specification pattern and the second protocol specification pattern is stored in the storage device of the controller 220. The protocol identification unit 222 of the controller 220 executes the protocol identification process based on the received optical wireless communication signal OSG. More specifically, the protocol identification unit 222 identifies the applied protocol applied to the received optical wireless communication signal OSG, based on the protocol specification pattern included in the received optical wireless communication signal OSG. When the protocol specification pattern included in the received optical wireless communication signal OSG is the first protocol specification pattern, the protocol identification unit 222 determines that the applied protocol is the first protocol. On the other hand, when the protocol specification pattern included in the received optical wireless communication signal OSG is the second protocol specification pattern, the protocol identification unit 222 determines that the applied protocol is the second protocol.

### 4-2. Second Example

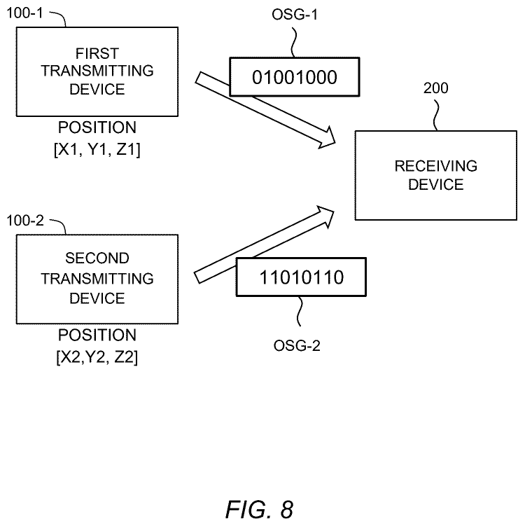

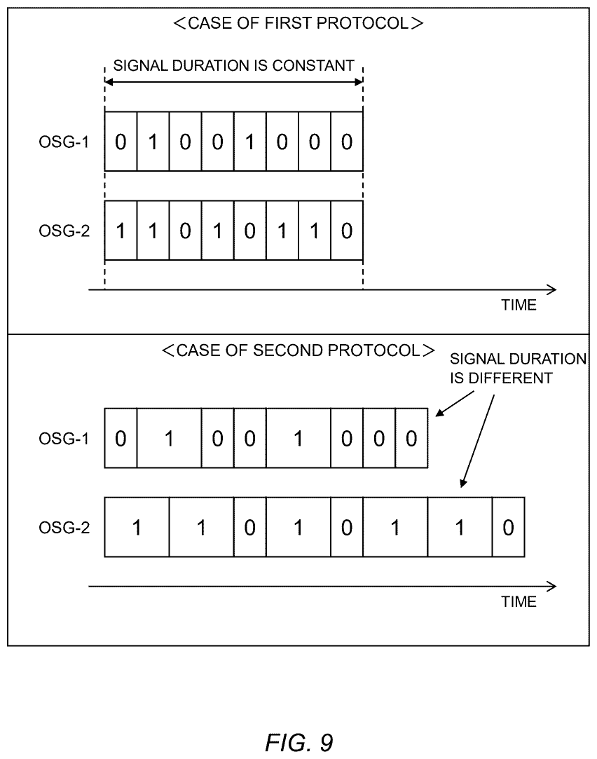

FIGS. 8 and 9 are conceptual diagrams for explaining a second example of the protocol identification process. In the second example as well, the optical wireless communication signal OSG having the same content is repeatedly transmitted from the same transmitting device 100. In the second example, the receiving device 200 receives a plurality of optical wireless communication signals OSG respectively transmitted from a plurality of transmitting devices 100, and executes the protocol identification process based on the plurality of optical wireless communication signals OSG.

As an example, a first transmitting device 100-1 and a second transmitting device 100-2 as shown in FIG. 8 is considered. The first transmitting device 100-1 repeatedly transmits a first optical wireless communication signal OSG-1 that represents first data (e.g., 01001000). For example, the first data indicate a position (X1, Y1, Z1) of the first transmitting device 100-1. Meanwhile, the second transmitting device 100-2 repeatedly transmits a second optical wireless communication signal OSG-2 that represents second data (e.g., 11010110). For example, the second data indicate the position (X2, Y2, Z2) of the second transmitting device 100-2. The position of the first transmitting device 100-1 and the position of the second transmitting device 100-2 are different from each other, and thus the contents of the first data and the second data are also different from each other. However, the first data and the second data have the same number of bits.

The first transmitting device 100-1 and the second transmitting device 100-2 use the same applied protocol. That is, the same applied protocol is applied to both the first optical wireless communication signal OSG-1 and the second optical wireless communication signal OSG-2.

The controller 220 of the receiving device 200 receives the first optical wireless communication signal OSG-1 and the second optical wireless communication signal OSG-2 through the event camera 210. The controller 220 may simultaneously receive both the first optical wireless communication signal OSG-1 and the second optical wireless communication signal OSG-2. Since the position of the first transmitting device 100-1 and the position of the second transmitting device 100-2 are different from each other, the first optical wireless communication signal OSG-1 and the second optical wireless communication signal OSG-2 are received simultaneously at different pixels of the event camera 210. The protocol identification unit 222 performs the protocol identification process by comparing the received first optical wireless communication signal OSG-1 and the received second optical wireless communication signal OSG-2.

First, a case of the first protocol will be explained. As described above, the first protocol represents data “0” and “1” based on whether or not there is a predetermined pattern of a combination of the rising edge ER and falling edge EF for each reference cycle T. As shown in the foregoing FIG. 5, in the case of the first protocol, a length of the data “0” and a length of data “1” are both equal to the reference cycle T. That is, the data “0” and the data “1” have the same length (duration). Meanwhile, the first data represented by the first optical wireless communication signal OSG-1 and the second data represented by the second optical wireless communication signal OSG-2 have the same number of bits. Therefore, as shown in FIG. 9, in the case of the first protocol, the duration of each single first optical wireless communication signal OSG-1 and the duration of each single second optical wireless communication signal OSG-2 are both the same constant time.

Next, a case of the second protocol will be explained. As described above, the second protocol uses only one of the rising edge ER and the falling edge EF as the onset, and represents data “0” and “1” based on the interval (period of time) between consecutive onsets. As shown in the foregoing FIG. 5, in the case of the second protocol, a length of the data “0” and a length of the data “1” are different from each other. Therefore, a duration of each single optical wireless communication signal OSG varies depending on a ratio of the data “0” to the data “1” included in the transmission data. Meanwhile, the first data represented by the first optical wireless communication signal OSG-1 and the second data represented by the second optical wireless communication signal OSG-2 have different contents. Accordingly, it is highly likely that the ratio of the data “0” to the data “1” included in the first data differs from the ratio of the data “0” to the data “1” included in the second data. Therefore, as shown in FIG. 9, in the case of the second protocol, it is highly likely that the duration of each single first optical wireless communication signal OSG-1 does not match the duration of each single second optical wireless communication signal OSG-2.

From the aforementioned viewpoint, the protocol identification unit 222 compares the duration of each single first optical wireless communication signal OSG-1 and the duration of each single second optical wireless communication signal OSG-2. When the duration of each single first optical wireless communication signal OSG-1 and the duration of each single second optical wireless communication signal OSG-2 are equal to each other, the protocol identification unit 222 determines that the applied protocol is the first protocol. On the other hand, when the duration of each single first optical wireless communication signal OSG-1 and the duration of each single second optical wireless communication signal OSG-2 are different from each other, the protocol identification unit 222 determines that the applied protocol is the second protocol.

According to the second example described above, the protocol specification pattern is unnecessary, and thus the length of the optical wireless communication signal OSG is reduced.

### 4-3. Third Example

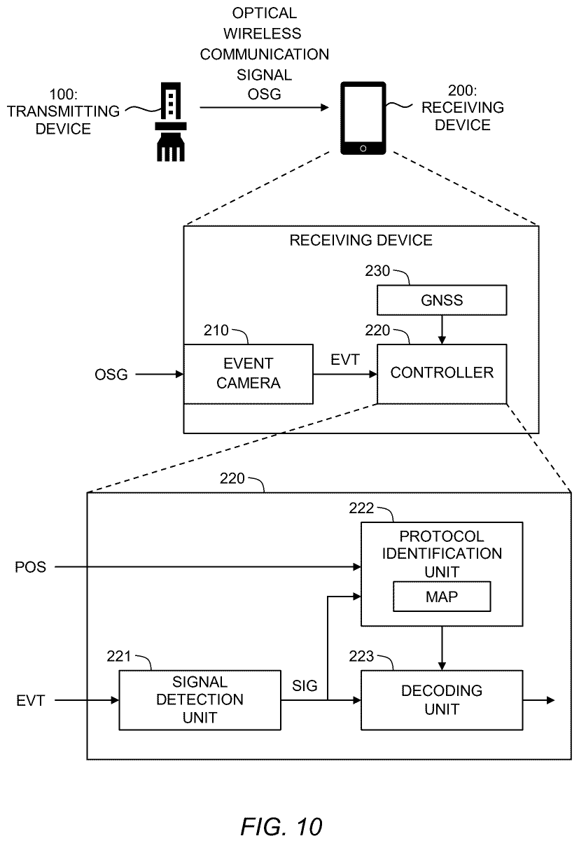

FIG. 10 is a conceptual diagram for explaining a third example of the protocol identification process. In the third example, the protocol is predetermined for each area. The controller 220 of the receiving device 200 retains a protocol distribution map MAP indicating the protocol for each area. More specifically, the protocol distribution map MAP is stored in the storage device of the controller 220. The controller 220 may download the protocol distribution map MAP from a management server.

The protocol identification unit 222 acquires position information POS indicating a position of the receiving device 200. For example, the position information POS may be obtained by a GNSS (Global Navigation Satellite System) sensor 230 mounted on the receiving device 200. Then, the protocol identification unit 222 identifies, based on the protocol distribution map MAP, a protocol associated with the position of the receiving device 200 as the applied protocol.

### 5. Sensitivity Setting Process

Sensitivity of the event camera 210 is variable. The controller 220 of the receiving device 200 may dynamically set (change) the sensitivity of the event camera 210.

### 5-1. Various Sensitivity Settings

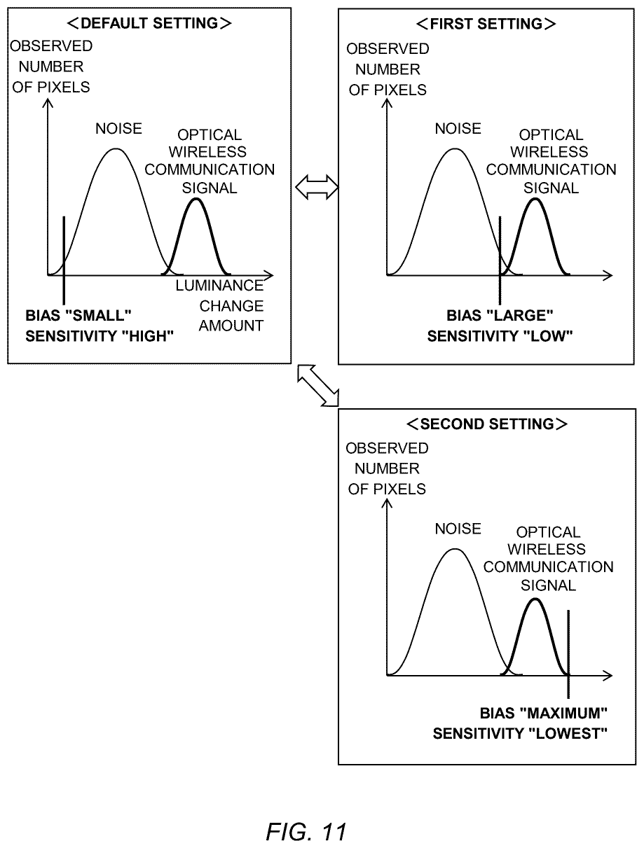

FIG. 11 is a conceptual diagram for explaining examples of setting of the sensitivity of the event camera 210. As in the part (B) of the foregoing FIG. 4, the vertical axis represents the number of pixels at which events are observed, and the horizontal axis represents the amount of change in luminance. The amount of change in luminance of the optical wireless communication signal OSG is greater than that of the noise. As the sensitivity increases, even smaller changes in luminance become detectable. A bias indicates the minimum amount of change in luminance that the event camera 210 is able to detect. That is, the event camera 210 detects changes in luminance that are equal to or greater than the bias. The bias is a concept inverse to the sensitivity. When the bias is small, the sensitivity is high. Conversely, when the bias is large, the sensitivity is low.

The application of the event camera 210 is not necessarily limited to the optical wireless communication. Therefore, in a default setting, the sensitivity (the bias) is set such that both the optical wireless communication signal OSG and the noise can be detected.

In a first setting, the bias is larger than that in the default setting, and the sensitivity is lower than that in the default setting. In particular, in the first setting, the sensitivity (the bias) is set such that the optical wireless communication signal OSG can be detected sufficiently while the noise can be excluded substantially. In the case of the first setting, the signal-to-noise ratio (S/N ratio) of the optical wireless communication signal OSG is improved. It can be said that the first setting is a sensitivity setting suitable for receiving the optical wireless communication signal OSG. Furthermore, since the noise is not detected, the amount of the event data EVT is reduced accordingly. Since the amount of the event data EVT is reduced, occurrence of a situation where the event data EVT exceeds a communication capacity is suppressed. As a result, lost (drop) of essential data is suppressed. Furthermore, the reduction in the data amount contributes to lowering processing load, memory usage, and power consumption.

In a second setting, the bias is even greater than that in the first setting, and the sensitivity is further lower than that in the first setting. In the second setting, not only the noise but also the optical wireless communication signal OSG becomes difficult to detect.

### 5-2. Example of Sensitivity Setting Process

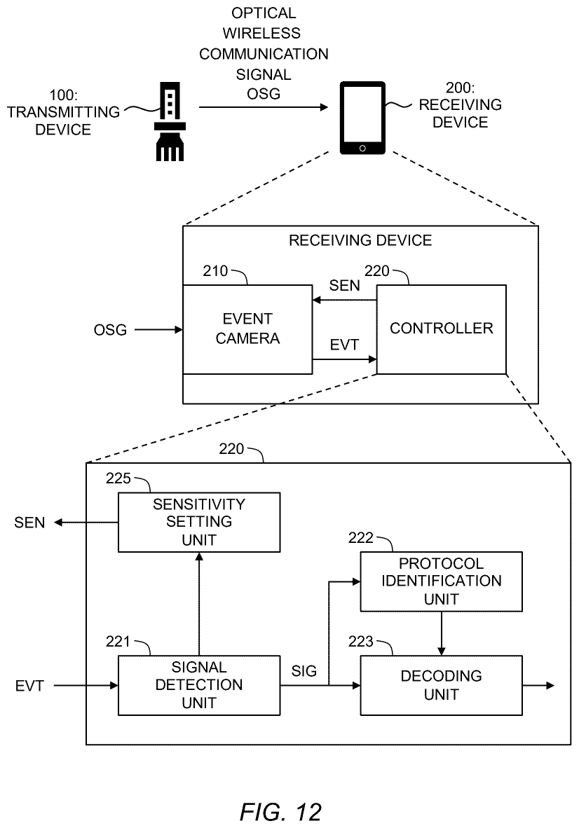

FIG. 12 is a block diagram for explaining an example of a sensitivity setting process. The controller 220 of the receiving device 200 further includes a sensitivity setting unit 225. The sensitivity setting unit 225 dynamically sets the sensitivity of the event camera 210. More specifically, the sensitivity setting unit 225 outputs sensitivity setting information SEN, which specifies the sensitivity setting of the event camera 210, to the event camera 210. The event camera 210 operates in accordance with the sensitivity setting specified by the sensitivity setting information SEN.

As described above, the signal detection unit 221 detects the start of the reception of the optical wireless communication signal OSG. The signal detection unit 221 notifies the sensitivity setting unit 225 that the reception of the optical wireless communication signal OSG is started. In response to the start of the reception of the optical wireless communication signal OSG, the sensitivity setting unit 225 changes the sensitivity of the event camera 210 from the default setting to the first setting. Due to the first setting, the noise is not detected and thus the S/N ratio of the optical wireless communication signal OSG is improved. Furthermore, since the noise is not detected, the amount of the event data EVT is reduced accordingly. Since the amount of the event data EVT is reduced, occurrence of a situation where the event data EVT exceeds a communication capacity is suppressed. As a result, lost (drop) of essential data is suppressed. Furthermore, the reduction in the data amount contributes to lowering processing load, memory usage, and power consumption.

The signal detection unit 221 can also detect end of the reception of the optical wireless communication signal OSG. For example, when the events of the specific high-frequency band (several hundred Hz to several hundred kHz) are no longer detected, the signal detection unit 221 determines that the reception of the optical wireless communication signal OSG is ended. The signal detection unit 221 notifies the sensitivity setting unit 225 that the reception of the optical wireless communication signal OSG is ended. In response to the end of the reception of the optical wireless communication signal OSG, the sensitivity setting unit 225 changes the sensitivity of the event camera 210 from the first setting back to the default setting.

### 5-3. Sensitivity Setting Process Considering Applied Protocol

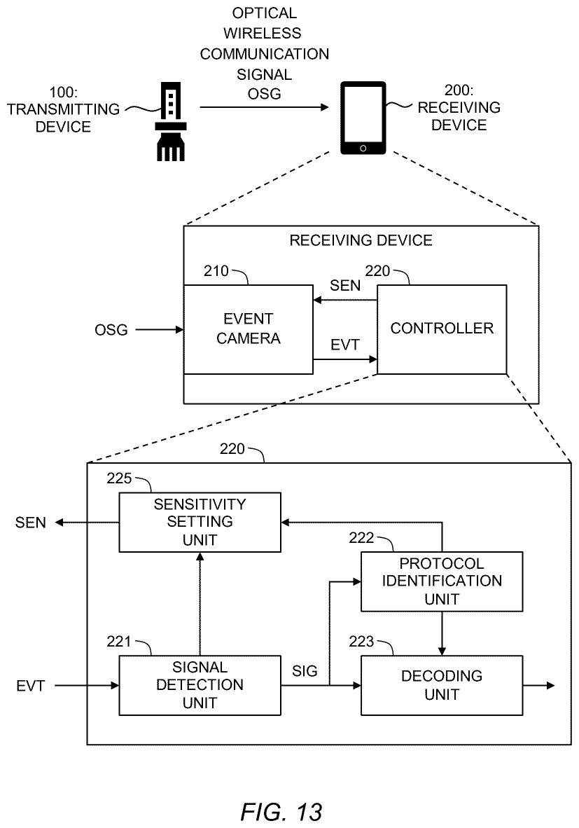

FIG. 13 is a block diagram for explaining the sensitivity setting process considering the applied protocol. As described above, in response to the start of the reception of the optical wireless communication signal OSG, the protocol identification unit 222 identifies the applied protocol applied to the received optical wireless communication signal OSG. The protocol identification unit 222 notifies the sensitivity setting unit 225 of the applied protocol. The sensitivity setting unit 225 dynamically sets the sensitivity of the event camera 210 in accordance with the applied protocol.

The first protocol represents the data “0” and “1” by using both the rising edge ER and the falling edge EF. When the applied protocol is the first protocol, the sensitivity setting unit 225 changes the sensitivity to both the rising edge ER and the falling edge EF from the default setting to the first setting. That is, the sensitivity setting unit 225 reduces the sensitivity to both the rising edge ER and the falling edge EF as compared with that in the default setting. This is the same as the example shown in the aforementioned FIG. 12.

On the other hand, the second protocol represents the data “0” and “1” by using only one of the rising edge ER and the falling edge EF. This means that it is not necessary to detect the other of the rising edge ER and the falling edge EF. Therefore, when the applied protocol is the second protocol, the sensitivity setting unit 225 sets the sensitivity to the unused one of the rising edge ER and the falling edge EF to the second setting. That is, the sensitivity setting unit 225 further reduces the sensitivity to the unused one of the rising edge ER and the falling edge EF, as compared with that in the case of the first protocol.

For example, in the example shown in FIG. 5, the second protocol represents the data “0” and “1” by using only the rising edge ER. This means that there is no need to detect the falling edge EF. Therefore, when the applied protocol is the second protocol, the sensitivity setting section 225 changes the sensitivity to the rising edge ER from the default setting to the first setting, and changes the sensitivity to the falling edge EF from the default setting to the second setting.

As described above, according to the example shown in FIG. 13, it becomes possible to appropriately set the sensitivity of the event camera 210 in accordance with the applied protocol. In particular, when the applied protocol is the second protocol, it becomes possible to significantly reduce the amount of the event data EVT, since unnecessary events are no longer detected. The reduction in the data amount contributes to lowering processing load, memory usage, and power consumption.

### 6. Changing Protocol

The transmitting device 100 may randomly change the applied protocol at a predetermined interval. The receiving device 200 is able to follow the change in the applied protocol by means of the aforementioned protocol identification process. Randomly changing the applied protocol can increase security.

What is claimed is:

1. A receiving device comprising:
an event camera configured to detect a rising edge and a falling edge of luminance as events; and
a controller configured to receive, through the event camera, an optical wireless communication signal transmitted from a transmitting device, wherein
a protocol defines how data is represented in the optical wireless communication signal,
and
the controller is configured to:
when start of reception of the optical wireless communication signal is detected, execute a protocol identification process that identifies an applied protocol applied to the received optical wireless communication signal; and
after the protocol identification process, recognize data represented by the optical wireless communication signal based on the applied protocol.

2. The receiving device according to claim 1, wherein
the controller is further configured to dynamically set sensitivity of the event camera in accordance with the applied protocol.

3. The receiving device according to claim 2, wherein
a first protocol represents data by using both the rising edge and the falling edge,
a second protocol represents data by using only one of the rising edge and the falling edge, and
when the applied protocol is the second protocol, the controller is configured to reduce the sensitivity of the event camera to another of the rising edge and the falling edge as compared with a case of the first protocol.

4. The receiving device according to claim 3, wherein
when the applied protocol is the first protocol, the controller is configured to reduce the sensitivity of the event camera to both the rising edge and the falling edge as compared with that in a default setting.

5. The receiving device according to claim 1, wherein
the optical wireless communication signal with a same content is repeatedly transmitted from a same transmitting device, and
the controller is configured to execute the protocol identification process based on the received optical wireless communication signal.

6. The receiving device according to claim 5, wherein
the optical wireless communication signal includes a protocol specification pattern indicating the applied protocol applied to the optical wireless communication signal, and
the controller is configured to identify the applied protocol based on the protocol specification pattern included in the received optical wireless communication signal.

7. The receiving device according to claim 5, wherein
a first transmitting device repeatedly transmits a first optical wireless communication signal representing first data as the optical wireless communication signal,
a second transmitting device repeatedly transmits a second optical wireless communication signal representing second data as the optical wireless communication signal,
a same protocol is applied to the first optical wireless communication signal and the second optical wireless communication signal,
the first data and the second data differ in content but have a same number of bits, and
the controller is configured to:
receive the first optical wireless communication signal and the second optical wireless communication signal through the event camera; and
identify the applied protocol based on a duration of each single first optical wireless communication signal and a duration of each single second optical wireless communication signal.

8. The receiving device according to claim 7, wherein
the first protocol represents data based on whether or not there is a predetermined pattern of a combination of the rising edge and the falling edge for each predetermined period of time,
the second protocol represents data based on an interval between consecutive onsets, wherein one of the rising edge and the falling edge is used as an onset, and
the controller is further configured to:
determine that the applied protocol is the first protocol, when the duration of each single first optical wireless communication signal and the duration of each single second optical wireless communication signal are equal to each other; and
determine that the applied protocol is the second protocol, when the duration of each single first optical wireless communication signal and the duration of each single second optical wireless communication signal are different from each other.

9. The receiving device according to claim 1, wherein
the protocol is predetermined for each area, and
the controller is configured to identify a protocol associated with a position of the receiving device as the applied protocol, based on a protocol distribution map indicating the protocol for each area.

10. An optical wireless communication system comprising:
a transmitting device configured to transmit an optical wireless communication signal; and
a receiving device configured to receive the optical wireless communication signal transmitted from the transmitting device, wherein
the receiving device is provided with an event camera that detects a rising edge and a falling edge of luminance as events, and is configured to receive the optical wireless communication signal through the event camera,
a protocol defines how data is represented in the optical wireless communication signal,
the transmitting device encodes transmission data in accordance with a certain applied protocol to generate the optical wireless communication signal, and
the receiving device is configured to:
when start of reception of the optical wireless communication signal is detected, execute a protocol identification process that identifies the applied protocol applied to the received optical wireless communication signal; and
after the protocol identification process, recognize the transmission data represented by the optical wireless communication signal based on the applied protocol.
